(19) United States
(12) Patent Application Publication
(10) Pub. No.: US 2023/0205789 A9
(43) Pub. Date: Jun. 29, 2023

(54) METHOD OF ROLLING RESTART BASED ON ESGYNDB DATABASE

(71) Applicant: Guizhou Esgyn Information Technology Co., Ltd, Guiyang City (CN)

(72) Inventors: Kaihua Xu, Guiyang City (CN); Shengchen Ma, Guiyang City (CN); Tianhang Shi, Guiyang City (CN)

(21) Appl. No.: 17/127,025

(22) Filed: Dec. 18, 2020

(30) Foreign Application Priority Data
Aug. 24, 2020 (CN) 202010859509.7

(51) Int. Cl. G06F 16/28; G06F 16/21; G06F 9/455; G06F 11/14; H04L 29/06

(52) U.S. Cl. CPC G06F 16/283; G06F 16/217; G06F 9/45512; G06F 11/1438; H04L 67/42

(57) ABSTRACT

This disclosure discloses a method for rolling restart based on EsgynDB Database, comprising the following steps: S1: the ZooKeeper in the system is used as the coordinator to update the MXOSRVR state required to be restarted in the instruction according to the framework of EsgynDB Database; S2: when MXOSRVR discovers that its state has been updated to “to be restarted”, it will add a piece of string information to the next information returned to Driver to inform the client that MXOSRVR is in the state of “to be restarted”; S3: when Driver knows that MXOSRVR requires to be restarted through parsing the newly added information by string, the client will reconnect according to the security point state of the whole business state.

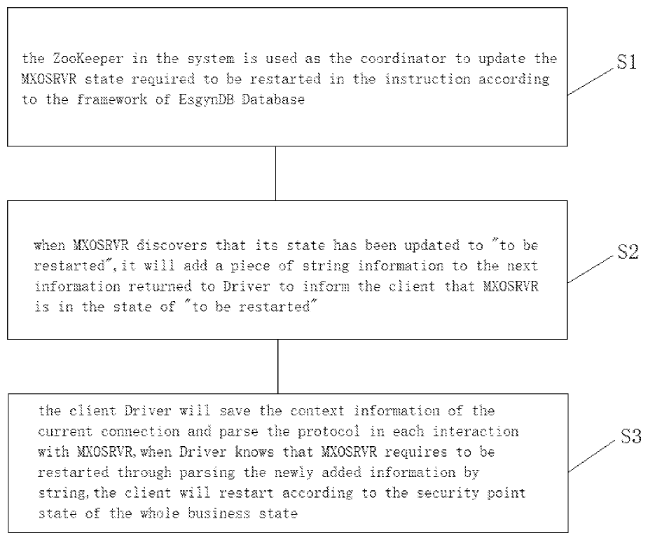

This application claims priority to China Patent Application No. 2020108595097, filed on Aug. 25, 2020. The contents of the above-identified applications are incorporated herein by reference in their entirety.

### TECHNICAL FIELD

The disclosure relates to the technical field of a distributed database, more specifically, to a method of rolling restart based on EsgynDB Database.

### BACKGROUND

As the infrastructure component of software, the database has high requirements for stability and security. In the production environment, database services basically belong to the non-shutdown state. Although EsgynDB Database is a new generation of HTAP distributed databases, it is not mature enough in some functions. At present, EsgynDB Database already has the database restart function, but in the restart phase, the database service needs to be stopped, which is still insufficient in the harsh production environment.

Therefore, how to provide a method of rolling restart based on EsgynDB Database has became an urgent problem to be solved for the skilled person in this art.

### SUMMARY

In view of this, this disclosure provides a method for rolling restart based on EsgynDB Database, which realizes the rolling restart of the whole database service without affecting the existing and running services, and improves the stability of EsgynDB data.

In order to achieve the above-mentioned purposes, the technical solutions are implemented as follows:

A method of rolling restart based on EsgynDB Database, comprising the following steps:

S1: the ZooKeeper in the system is used as the coordinator to update the MXOSRVR state required to be restarted in the instruction according to the framework of EsgynDB Database;

S2: when MXOSRVR discovers that its state has been updated to “to be restarted”, it will add a piece of string information to the next information returned to Driver to inform the client that MXOSRVR is in the state of “to be restarted”;

S3: the client Driver will keep the context information of the current connection and parse the protocol in each interaction with MXOSRVR, when Driver knows that MXOSRVR requires to be restarted through parsing the newly added information by string, the client will reconnect according to the security point state of the whole business state.

Preferably, the method of updating the MXOSRVR state required to be restarted in the instruction includes:

a new command-line tool is added, which provides an interface of scrolling restart command and provides the fine control of the command, the ZooKeeper in the EsgynDB Cluster is used as a coordinator by the command-line tool to update the MXOSRVR state required to be restarted in the command.

Preferably, the command line tool requires two parameters, a node name and command timeout.

Preferably, the restart method is taken by the client according to the security point state of the whole business state includes:

judge the security point state of the whole business state: state 1: on the condition the client Driver finds that the whole business state is in a security point state, it will actively disconnect the current connection, and then immediately perform the operation of reconnection, when the reconnection is completed, according to the kept context information, the client will execute some operations again to restore to the context state before the connection is disconnected, and then continue to execute its business operations when MXOSRVR finds that the connection is closed, it actively exits and restarts; state 2: on the condition the client Driver does not find that the whole business state is in the security point state, it will continue to perform the client's business operations until the Driver enters a security point state and repeats the operation in State 1

The advantages of the disclosure lie in:

The invention realizes a dynamic restart function and realizes the rolling restart of the whole database service by means of the advantages of the distributed architecture itself without affecting the existing and running services, and improves the stability of EsgynDB data. Not only may the online scrolling restart of EsgynDB database in the production environment be realized, but also the customer application may be realized without perception, and the running business may not be affected. In addition, it controls EsgynDB data service nodes in a more refined model, which greatly improves the system stability and security of the entire database cluster.

### BRIEF DESCRIPTION OF THE DRAWINGS

The sole FIGURE is a flow chart of the method in this invention.

### DETAILED DESCRIPTION

The technical solutions in the embodiments in the invention will be clearly and completely described in combination with the drawings in the embodiments of the invention.

Directing to the defects and problems of EsgynDB at present, the invention adds

new attributes, return values and the like to the original database communication protocol to realize the service restart without perception for the client of the database.

Referring to the sole FIGURE, the invention provides a method of scrolling restart based on EsgynDB Database, which includes the following steps:

S1: the ZooKeeper in the system is used as the coordinator to update the MXOSRVR state required to be restarted in the instruction according to the framework of EsgynDB Database;

A new command-line tool is added, which provides an interface of scrolling restart command and provides the fine control of the command such as nodes that need to be restarted, restart time, etc. Using the ZooKeeper that exists in the EsgynDB cluster as the coordinator, the command line tool updates the state of the MXOSRVR (provided process name of the EsgynDB database service) that is required to be restarted in the instruction.

S2: Regarding the MXOSRVR, the service provider, of EsgynDB database, when the process finds that its state has been updated to be restarted, MXOSRVR will add a piece of string information to the next information returned to Driver to inform the client that MXOSRVR is in the state of “to be restarted”.

S3: The client Driver will keep the context information of the current connection and parse the protocol in each interaction with MXOSRVR When Driver knows that MXOSRVR requires to be restarted through parsing the newly added information by string, the client will firstly judge whether the whole business state is in a security point state (the current transaction has been completed).

State 1: If the client Driver finds that the whole business state is in a security point state, it will actively disconnect the current connection, and then immediately perform the operation of reconnection. When the reconnection is completed, the client will execute some operations again to restore to the context state before the connection is disconnected according to the kept context information, and then continue to execute its business operations. When MXOSRVR finds that the connection is closed, it actively exits and restarts; State 2: If the client Driver does not find that the whole business state is in the security point state, it will continue to perform the client's business operations until the Driver enters a security point state and repeats the operation in State 1.

At this point, the whole restart process is completed, and the business of the whole client is not affected, and the connection is transferred without the customer's perception. The original MXOSRVR has been restarted.

The invention realizes a dynamic restart function, utilizing the advantages of the distributed architecture itself, and the original component ZooKeeper in EsgynDB, and realizes the rolling restart of the whole database service on the basis of not affecting the original communication protocol, without affecting the existing and running services, and improves the stability of EsgynDB data. Not only may the online scrolling restart of EsgynDB database in the production environment be realized, but also the customer application may be realized without perception, and the running business may not be affected. In addition, it controls EsgynDB data service nodes in a more refined model, which greatly improves the system stability and security of the entire database cluster.

In stand-alone database systems, it is proximate to database result set caching, for instance, MySQL table caching technology. However, it is very limited to the application scope for the result set caching. Once there are any changes to the query, the cache cannot be used. In most scenarios, the same query will not be used repeatedly, thus making the availability of this technology low.

However, the cache in the invention is that of complete data in the table of data. The same results can be obtained by accessing to the cache and the table, respectively. It would be invalid due to changes in the query itself. Therefore, it may be widely applied. All query statements of related tables may benefit from the cache.

In the distributed database system, the closest technology is “broadcast table” technology. That is, the table is completely copied in multiple copies and the same copy is saved on each physical node of the cluster. First, the data is still saved in the disk. Second, accessing data needs to cross process boundaries.

However, the invention places the cache in the main actuator, thus avoiding the cross-process access of very expensive operation, and the technology disclosed in our invention is more advanced.

Each embodiment in the specification is described in a progressive manner, focusing on their differences from other embodiments, and the same and similar parts between respective embodiments can be referred to each other. In terms of the apparatus disclosed in the embodiment, the description about it is relatively simple, since it corresponds to the method disclosed in the embodiment, and reference may be made to the description of the method section for relevant points.

The above description of the disclosed embodiments enables the skilled person in this art to practice or use the invention. It will be apparent to the skilled person in this art for making various modifications to these embodiments. And the general principles defined herein may be implemented in other embodiments without departing from the spirit or scope of the invention. Accordingly, the invention will not be limited to these embodiments shown herein but will comply with the widest scope conforming to the principles and novel features disclosed herein.

What is claimed is:

1. A method of rolling restart based on EsgynDB Database, comprising the following steps:
S1: the ZooKeeper in the system is used as the coordinator to update the MXOSRVR state required to be restarted in the instruction according to the framework of EsgynDB Database;
S2: when MXOSRVR discovers that its state has been updated to “to be restarted”, it will add a piece of string information to the next information returned to Driver to inform the client that MXOSRVR is in the state of “to be restarted”;
S3: the client Driver will keep the context information of the current connection and parse the protocol in each interaction with MXOSRVR, when Driver knows that MXOSRVR requires to be restarted through parsing the newly added information by string, the client will reconnect according to the security point state of the whole business state.

2. The method of claim 1, wherein the method of updating the MXOSRVR state required to be restarted in the instruction includes:
a new command-line tool is added, which provides an interface of scrolling restart command and provides the fine control of the command, the command-line tool uses ZooKeeper in the EsgynDB Cluster as a coordinator to update the MXOSRVR state required to be restarted in the command.

3. The method of claim 2, wherein the command line tool includes a node that needs to be restarted and the restart time.

4. The method of claim 1, wherein the restart method achieved by the client according to the security point state of the whole business state includes:
judging the security point state of the whole business state: state 1: if the client Driver finds that the whole business state is in a security point state, it will actively disconnect the current connection, and then immediately perform the operation of reconnection, when the reconnection is completed, the client will execute some operations again to restore to the context state before the connection is disconnected according to the kept context information, and then continue to execute its business operations, and when MXOSRVR finds that the connection is closed, it actively exits and restarts; state 2: if the client Driver does not find that the whole business state is in the security point state, it will continue to perform the client's business operations until the Driver enters a security point state and then repeats the operation in State 1.
